(19) United States
(12) Patent Application Publication
(10) Pub. No.: US 2013/0044059 A1
(43) Pub. Date: Feb. 21, 2013

(54) TOUCH-CONTROL TYPE KEYBOARD

(71) Applicant: SHAO-MING FU, Tu-Cheng (TW)

(72) Inventor: SHAO-MING FU, Tu-Cheng (TW)

(73) Assignee: TIANJIN FUNAYUANCHUANG TECHNOLOGY CO.,LTD., Tianjin (CN)

(21) Appl. No.: 13/337,255

(22) Filed: Dec. 26, 2011

(30) Foreign Application Priority Data
Aug. 17, 2011 (CN) 201110235977.8

(51) Int. Cl. G06F 3/02

(52) U.S. Cl. 345/168

(57) ABSTRACT

A touch-control type keyboard includes a transparent cover board and a touch-control module laminated with the transparent cover board. The transparent cover board includes an outer surface and an inner surface opposite to the outer surface. The outer surface of the transparent cover board includes a tactual zone and a relative anti-tactual zone. The tactual zone includes micro structures on the outer surface.

### CROSS-REFERENCE TO RELATED APPLICATIONS

This application claims all benefits accruing under 35 U.S.C. §119 from China Patent Application No. 201110235977.8, filed on Aug. 17, 2011, in the China Intellectual Property Office, the contents of which are hereby incorporated by reference.

### BACKGROUND

1. Technical Field

The disclosure generally relates to keyboards, and particularly to a touch-control type keyboard.

2. Description of Related Art

A keyboard is commonly used to input information into an electronic device. Referring to FIG. 17, a mechanical typewriter-style keyboard has a plurality of keys marked with symbols. Referring to FIG. 18, a key system has a key cap 2, a base board 4, a connecting structure 6, and a pressure sensor. The base board 4 is arranged below the key cap 2. The connecting structure 6 connects the key cap 2 to the base board 4, and enables upward and downward movements of the key cap 2. The connecting structure 6 includes two connecting pads 8 and an elastic member 9. The two connecting pads 8 are connected to each other and are capable of being rotated. The elastic member 9 is located under the key cap 2 to elastically support the key cap 2. Attempts have been made to decrease the size of the connecting pads to make a thinner keyboard. However, the mechanical typewriter-style keyboard must travel a certain distance to press the key. Thus, it is difficult to further decrease the thickness of the keyboard.

Portable devices having touch panels, such as touch-control type mobile phones and touch pads, have been widely used. The touch-control type mobile phone has a touch panel as an input device on the mobile phone display. The touch panel has a small thickness, and therefore, the overall thickness of the touch-control type mobile phone is small. In use, a keyboard image is displayed on the display. The user touches a corresponding position on the touch panel of a displayed key to input the information corresponding to the key.

However, during typing, the user must locate the position of the key by seeing the displayed keyboard image. This process delays the typing speed. Therefore, the typing on a touch panel is much slower than using a conventional mechanical typewriter-style keyboard, and typing errors often occur.

What is needed, therefore, is to provide a touch-control type keyboard by which users can distinguish the positions of keys without a visual sensation and effectively decrease the typing errors, and increase the typing speed.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 is an exploded view of a first embodiment of a touch-control type keyboard.

FIG. 2 is a side view of the touch-control type keyboard of FIG. 1.

FIG. 3 is a top partial view of another embodiment of the touch-control type keyboard.

FIG. 4 is a top partial view of another embodiment of the touch-control type keyboard.

FIG. 5 is a top partial view of another embodiment of the touch-control type keyboard.

FIG. 6 is a top view of another embodiment of the touch-control type keyboard.

FIG. 7 is a side view of a second embodiment of the touch-control type keyboard.

FIG. 8 is an exploded view of the touch-control type keyboard of FIG. 7.

FIG. 9 is a side view of a third embodiment of the touch-control type keyboard.

FIG. 10 is a side view of a fourth embodiment of the touch-control type keyboard.

FIG. 11 is a side view of a fifth embodiment of the touch-control type keyboard.

FIG. 12 is side view of another embodiment of a transparent cover board of the touch-control type keyboard.

FIG. 13 is a side view of a sixth embodiment of the touch-control type keyboard.

FIG. 14 is a side view of a seventh embodiment of the touch-control type keyboard.

FIG. 15 is an exploded view of the touch-control type keyboard of FIG. 14.

FIG. 16 is a side view of an eighth embodiment of the touch-control type keyboard.

FIG. 17 is a structure view of a keyboard in related art

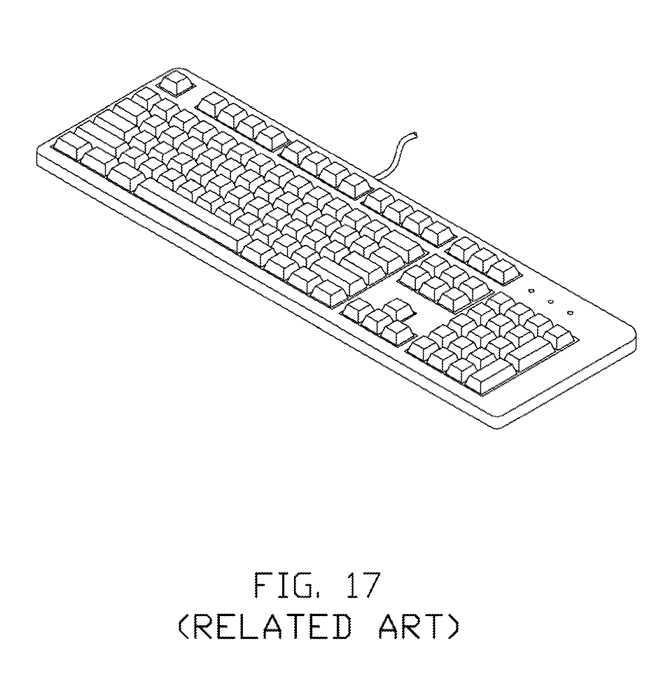

FIG. 18 is a structure view of a key structure of the keyboard in related art.

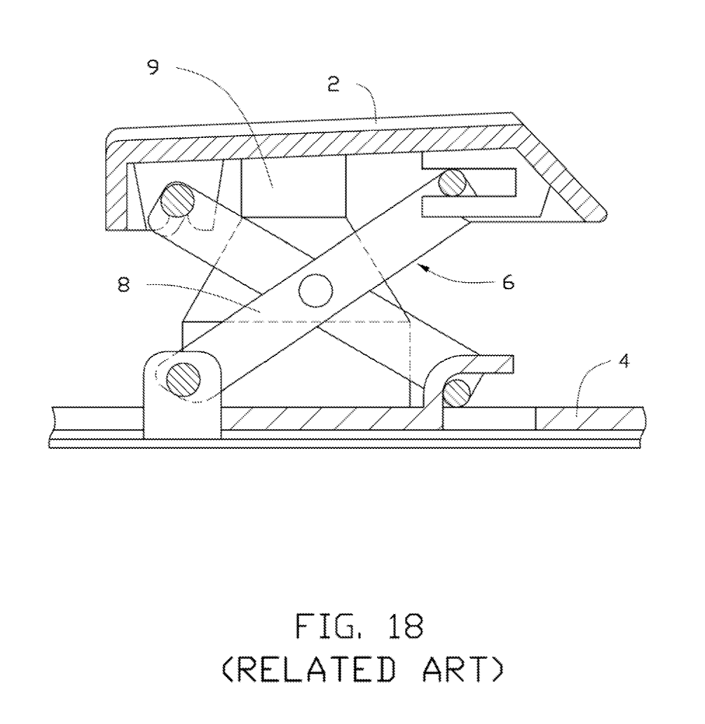

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

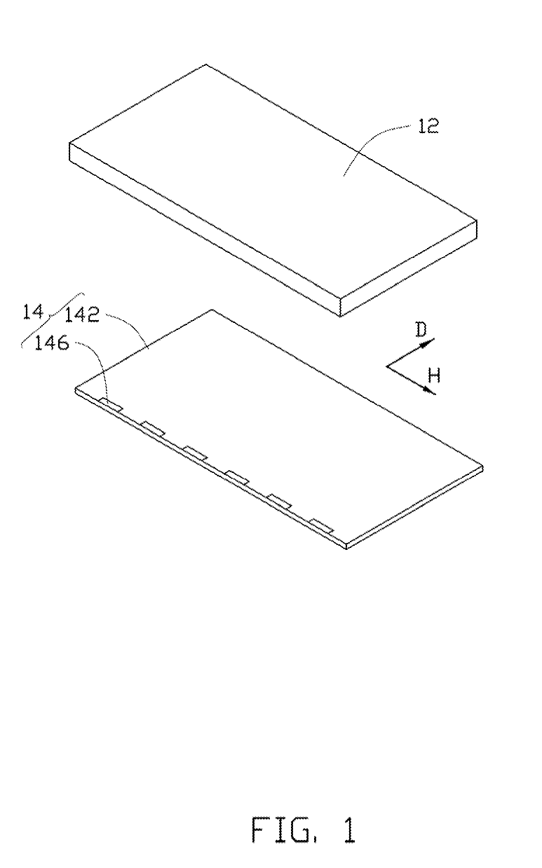

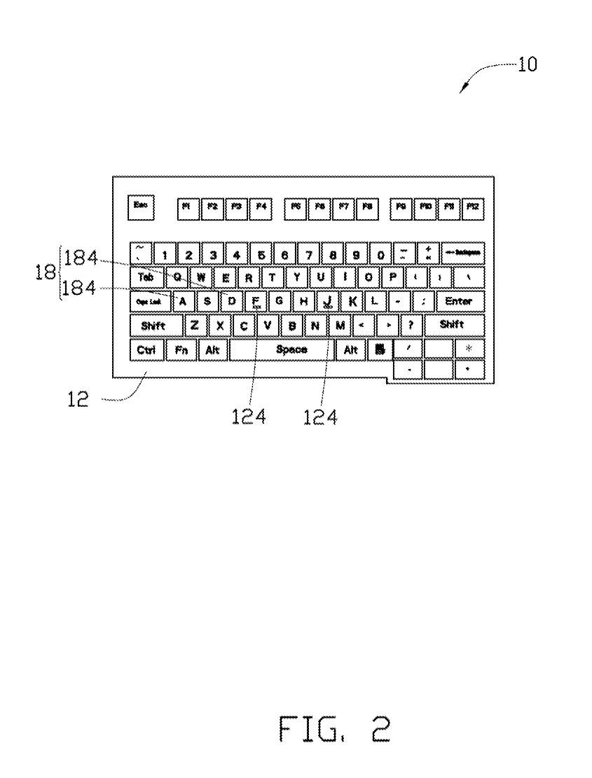

Referring to FIG. 1 and FIG. 2, a first embodiment of a touch-control type keyboard 10 includes a transparent cover board 12 and a touch-control module 14. The transparent cover board 12 is stacked on the touch-control module 14.

In one embodiment, the touch-control type keyboard 10 can be arranged on a displaying surface of a display. The user can see the display through the touch-control type keyboard 10. In another embodiment, the touch-control type keyboard 10 can be separated from the display.

The transparent cover board 12 is an integrated plate shaped structure. The transparent cover board 12 covers the touch-control module 14, and is in contact and fixed on the touch-control module 14. The transparent cover board 12 has an outer surface nearest to the user. The outer surface an operating surface of the touch-control type keyboard 10 for the user. The outer surface may be continuous. Some regions of the outer surface of the transparent cover board 12 are defined as a plurality of key regions of the touch-control type keyboard 10.

The outer surface of the transparent cover board 12 can include a touch-control sensing zone and a non-sensing zone. The touch-control sensing zone is capable of sensing a touch. The user inputs data through the touch-control sensing zone of the touch-control type keyboard 10 to an electronic device. For example, the touch-control sensing zone can be the regions of the keys in the keyboard 10. The non-sensing zone does not have the touch sensing function. For example, the non-sensing zone can be the perimeter portion near the edges of the keyboard 10. In one embodiment, the entire outer surface of the touch-control type keyboard 10 is a touch-control sensing zone. In another embodiment, the touch-control sensing zone can include another sensing region separated from the key regions. For example, the sensing region can be used as a touch pad for the user to control a cursor on a display.

The outer surface of the transparent cover board 12 can have a tactual zone and a relative anti-tactual zone. The outer surfaces of the tactual zone and the relative anti-tactual zone have different tactual sensations enabling the user to distinguish the tactual zone and the relative anti-tactual zone by touch. In this embodiment, the outer surfaces of the tactual zone and the relative anti-tactual zone have different surface structure. When the user touches the tactual zone, the user can feel the unique tactual sensations to differentiate the tactual zone from the anti-tactual zone. Therefore, the user can distinguish positions of keys by using the tactual zone. In the touch-control type keyboard 10, the transparent cover board 10 is an integrated continuous plate shaped structure, and the keys are different regions in the transparent cover board 10. The position of one tactual zone can correspond to the position of one key in the touch-control type keyboard 10. Not all of the keys need to have a corresponding tactual zone. In one embodiment, only one or two keys have the corresponding tactual zones at their positions. For example, in a QWERTY keyboard layout, only the two home keys, “F” and “J”, have a corresponding tactual zone. In another embodiment, the plurality of tactual zones can correspond to the positions of all the keys in a one to one manner. The difference between the tactual zone and the relative anti-tactual zone can be formed by the variation of the surface structure of the outer surface of the transparent cover board 12. The variation of the surface structure can be felt and distinguished by the fingers of a user. For example, the relative anti-tactual zone of the outer surface can be relatively smooth, and the tactual zone of the outer surface can be relatively rough. One or more micro structures such as concave-convex structures can be formed on the outer surface of the tactual zone to form a fluctuant surface.

In one embodiment, at least one touch-control sensing zone is also the tactual zone on the outer surface of the transparent cover board 12. The outer surface of the touch-control sensing zone and the outer surface of the non-sensing zone have different tactual sensations which enable the user to distinguish the touch-control sensing zone and the non-sensing zone by touch. In this embodiment, the outer surface of the touch-control sensing zone and the outer surface of the non-sensing zone have different surface structures. In another embodiment, the touch-control sensing zone can include a plurality of the tactual zones and a plurality of anti-tactual zones on the outer surface of the transparent cover board 12. The touch-control sensing zone of the outer surface of the transparent cover board 12 can include a plurality of keys.

In one embodiment, the outer surface of the tactual zone includes a concave-convex structure 124 for distinguishing the positions of the keys.

The concave-convex structure 124 of the transparent cover board 12 can be a concave structure (e.g., a recess), a convex structure (e.g., a protrusion), or a combination between the concave structure and the convex structure. The position of one key on the outer surface can only have one concave-convex structure 124. If the concave-convex structure 124 is a convex structure, each of the convex structures can be the position of one key. A shape of the convex structure can be hemispherical, cylindrical, frustum, prism, or symbol-shaped protrusions. If the concave-convex structure 124 is a concave structure, each of the concave structure can be the position of one key. A shape of the concave structure can be a recessed hemispherical, cylindrical, frustum, prism, or symbol-shaped recessions.

In the touch-control type keyboard 10, not all of the keys must have the concave-convex structure 124. For example, in a layout of a QWERTY keyboard, only the two keys, “F” and “J”, have a concave-convex structure 124, and the other regions of the outer surface can be relatively smooth. The surface of the other regions can also have a degree of roughness. However, the user can distinguish the concave-convex structures 124 by the roughness difference between the concave-convex structures 124 and the other regions. In another embodiment, each key position has one or more corresponding concave-convex structures 124.

In the first embodiment, the layout of the touch-control type keyboard 10 has a QWERTY layout. The concave-convex structures 124 on the outer surface of the transparent cover board 12 are two convexly rectangular horizontal bar shaped protrusions arranged only on the key positions of “F” and “J” to form two locating points. The outer surface of the transparent cover board 12 except for the two bar shaped protrusions is a relatively smooth and flat surface.

A material of the transparent cover board 12 can be a rigid material or a flexible material. The flexible material can be plastic or resin, such as polyethylene terephthalate (PET), poly(methyl methacrylate) (PMMA), polycarbonate (PC), Polyether sulfone (PES), cellulose acetate, polyvinyl chloride (PVC), benzocyclobutene (BCB), and acrylic resin. The rigid material can be glass or crystal. The transparent cover board 12 can be partially transparent or transparent. The material of the transparent cover board 12 can be an electrical insulator.

The convex structure can be formed on the outer surface of the transparent cover board 12 by providing the transparent cover board 12, forming a polymer material pattern layer on the outer surface of the transparent cover board 12, and solidifying the polymer material pattern layer. The polymer material pattern layer can be formed by screen painting or brushing. The polymer material pattern layer can be solidified by using a photo-curing or a thermo-curing. The polymer material pattern layer has a certain thickness, so that after the solidifying step, the convex structures have a certain height formed on the outer surface of the transparent cover board 12.

The concave structure can be formed on the outer surface of the transparent cover board 12 by providing the transparent cover board 12 and an imprinting stamp having a protruded imprinting pattern, pressing the imprinting stamp on the outer surface of the transparent cover board 12, and removing the imprinting stamp to form recesses having a certain depth on the outer surface of the transparent cover board 12.

The height of the convex structure and the depth of the concave structure can be in a range from about 50 microns to about 2 millimeters, to enable good tactility in use of the touch-control type keyboard 10. In one embodiment, the height of the convex structure is in a range from about 100 microns to about 500 microns.

In another embodiment, the transparent cover board 12 can be made by an injection molding method, and the concave or convex structures can be formed at the same time.

By forming a plurality of concave-convex structures 124 on the outer surface of the transparent cover board 12, the user can distinguish the positions of the keys by feeling the shapes of the concave-convex structures 124. The operating experience of the touch-control type keyboard 10 can be enhanced, the typing errors on the touch panel can be prevented, and the typing speed can be increased.

The touch-control module 14 can be a resistive type touch-control module or a capacitance type touch-control module. The resistive type touch-control module can works in a working principle of resistive type touch panel. The capacitance type touch-control module can works in a working principle of capacitance type touch panel. The touch-control module 14 can be a super-thin multi-point capacitance type touch-control module, which only includes an anisotropic impedance conductive layer 142 and a plurality of electrodes 146 electrically connected to the anisotropic impedance conductive layer 142. The anisotropic impedance conductive layer 142 is electrically conductive in any direction, but has a minimum electrical conductivity in a first direction, and a maximum electrical conductivity in a second direction. The first and second directions are parallel to a surface of the anisotropic impedance conductive layer 142. The first and second directions are usually perpendicular to each other but can intersect at any angle. The anisotropic impedance conductive layer 142 can be a carbon nanotube film.

The carbon nanotube film includes a plurality of carbon nanotubes. The plurality of carbon nanotubes are substantially aligned along a same direction and parallel to a surface of the carbon nanotube film. The carbon nanotube film has a maximum electrical conductivity at the aligned direction of the carbon nanotubes, and a minimum electrical conductivity at the direction perpendicular to the aligned direction of the carbon nanotubes. The minimum electrical conductivity is not zero. Thus, the carbon nanotube film is an anisotropic impedance film having the anisotropic impedance property. In the carbon nanotube film, a relatively low impedance direction D (substantially parallel to the aligned direction of the carbon nanotubes) can be perpendicular to a relatively high impedance direction H (substantially perpendicular to the aligned direction of the carbon nanotubes). Because of the anisotropic impedance property, the carbon nanotube film can sense multi touches at the same time.

The carbon nanotube film can be formed by drawing from a carbon nanotube array. In the carbon nanotube film drawn from the carbon nanotube array, the overall aligned direction of a majority of carbon nanotubes is substantially aligned along the same direction parallel to a surface of the carbon nanotube film. A majority of the carbon nanotubes are substantially aligned along the same direction in the carbon nanotube film. Along the aligned direction of the carbon nanotubes, each carbon nanotube is joined to adjacent carbon nanotubes end to end by van der Waals attractive force therebetween, whereby the carbon nanotube film is capable of being free-standing structure. The carbon nanotube film drawn from the carbon nanotube array is transparent. In one embodiment, the carbon nanotube film is substantially a pure film and consists essentially of just the carbon nanotubes, to increase the transparency of the touch-control module. There may be a minority of carbon nanotubes in the carbon nanotube film that are randomly aligned. However, the number of the randomly aligned carbon nanotubes is very small and does not affect the overall oriented alignment of the majority of carbon nanotubes in the carbon nanotube film. The majority of the carbon nanotubes in the carbon nanotube film that are substantially aligned along the same direction may not be exactly straight, and can be curved at a certain degree, or are not exactly aligned along the overall aligned direction, and can deviate from the overall aligned direction by a certain degree. Therefore, partial contacts can exist between the juxtaposed carbon nanotubes in the majority of the carbon nanotubes aligned along the same direction in the carbon nanotube film. A thickness of the carbon nanotube film at the thickest location is about 0.5 nanometers to about 100 microns (e.g., in a range from 0.5 nanometers to about 10 microns).

The plurality of electrodes 146 can be made of low resistance material such as copper, silver, and aluminum, to minimize the signal attenuation. In one embodiment, the electrodes 146 are made of silver paste. The plurality of electrodes 146 are arranged on a side edge of the carbon nanotube film. The side edge is substantially parallel to the relatively high impedance direction H, and perpendicular to the aligned direction of the carbon nanotubes in the carbon nanotube film. A length along the relatively high impedance direction H of each electrode 146 can be between about 1 mm to about 8 mm. A distance between two adjacent electrodes 146 can be between about 3 mm to about 5 mm. A signal input by each electrode transmitted to or received from the carbon nanotube film will primarily transmit along the relatively low impedance direction D. The touch-control module 14 can adopt the characteristic of the signal transmittance with the directional property as a determining basis of a touch location. It is to be understood that the size and pitch of the electrodes 146 can be varied upon a desired resolution and application field of the product.

More specifically, the touch-control module 14 can further include a driving-sensing circuit. The driving-sensing circuit is connected to at least a part of or all of the electrodes 146. When a finger of a user or a conductive medium touches the keyboard 10, a contact capacitance is formed between the anisotropic impedance conductive layer 142 and the finger (or the conductive medium). The contact capacitance can affect the capacitance of the anisotropic impedance conductive layer 142 at the touch position. The capacitance change of the anisotropic impedance conductive layer 142 caused by the contact capacitance can be detected by the driving-sensing circuit through the electrodes 146. The driving-sensing circuit can determine the contact position based on the value of signals conducted from the electrodes 146. The plurality of electrodes 146 are connected to the anisotropic impedance conductive layer 142 at different locations. Therefore, the electrodes 146 can detect the capacitance changes at different contact positions on the anisotropic impedance conductive layer 142 at the same time. Accordingly, the multi touch detection can be realized.

The signals received by every electrode 146 directly reflect a distance between the touch locations and the electrode 146, because the carbon nanotube film has the anisotropic impedance property. Therefore, the touch-control module 14 has a relatively superior sensing accuracy. The touch-control module 14 can also determine the touch location by directly reading the signal values received from the electrodes and comparing the signal values received by adjacent electrodes. Thus, the touch-control module 14 does not need a complicated driving method and calculating program. In general, the touch-control module 14 proposed by the present embodiment is a simple structure with high sensing accuracy, and simple driving method.

The touch-control type keyboard 10 can also include a keyboard marking layer 18. The keyboard marking layer 18 is located on the outer surface of the transparent cover board 12. The keyboard marking layer 18 includes a plurality of key symbols 184 used for marking the keys. The key symbols 184 can be English characters such as the letters “A” to “Z”, Arabic numerals, and other symbols.

The key symbols 184 can correspond to the positions of the keys in a one to one manner. The key symbols 184 can be transparent or partially transparent. The keyboard marking layer 18 uses key symbols 184 to visually mark the keys of the touch-control type keyboard 10. Therefore, the user can visually distinguish the positions of the keys. At the same time, the user can tactually distinguish the positions of the keys by using the concave-convex structures 124 formed on the outer surface of the transparent cover board 12. In one embodiment, the positions of the concave-convex structures 124 and the positions of the key symbols 184 correspond to each other in a one to one manner In the first embodiment, as shown in FIG. 2 on the outer surface of the transparent cover board 12, a key symbol “F” and a key symbol “J” are respectively located above the two concave-convex structures 124.

The shape of the key symbol 184 can be the same as or different from the shape of the concave-convex structure 124. The keyboard marking layer 18 can be formed on the outer surface of the transparent cover board 12 by a marking method such as screen printing, laser printing, etching, plating, and spraying.

The keyboard marking layer 18 is an optional structure. In some embodiments, the touch-control type keyboard 10 does not utilize a keyboard marking layer 18 to enable the user to visually distinguish the positions of the keys. For example, the concave-convex structure 124 on the key position has a symbol shape representing the name of the key. Therefore, the key is visually and tactually marked by the concave-convex structure 124.

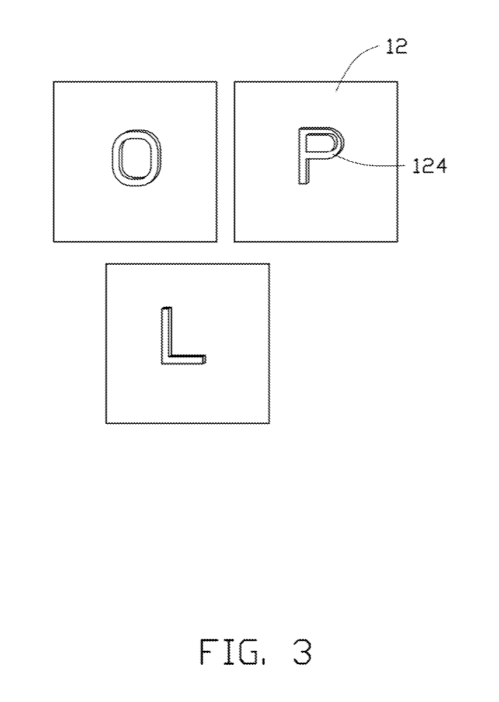

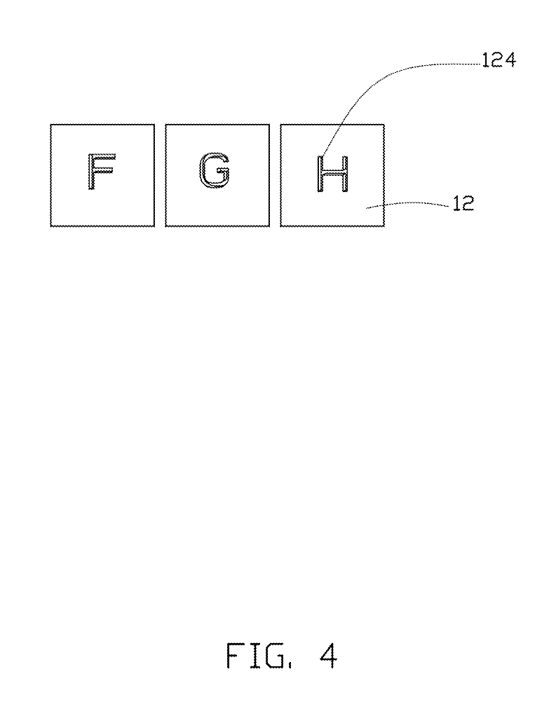

Referring to FIGS. 3 and 4, in another embodiment, the positions of all the keys of the touch-control type keyboard 10 have the corresponding concave-convex structures 124 in a one to one manner In FIG. 3, the concave-convex structures 124 are convex structures. In FIG. 4, the concave-convex structures 124 are concave structures. The concave-convex structures 124 are in the shape of symbols, such as the letters “A” to “Z”, numbers “0” to “9”, and other symbols. The convex structures can be formed by the screen printed polymer material layer. The colors of the polymer material layer can be different from the transparent cover board 12. Therefore, the convex structures can be visually different from the transparent cover board 12.

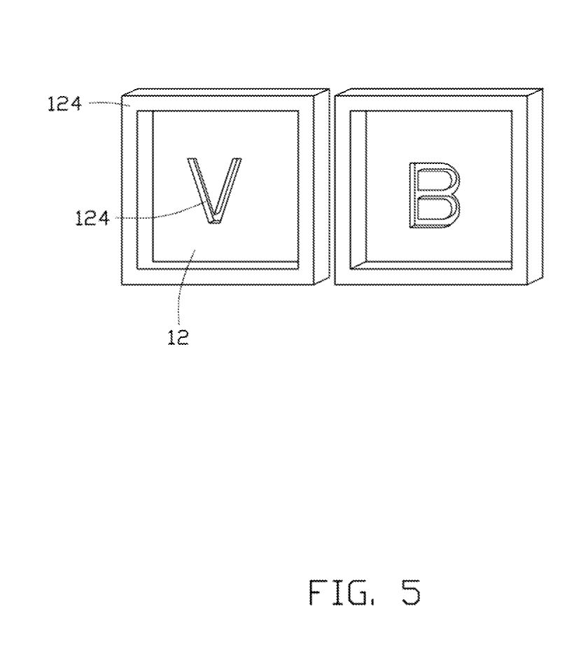

Referring to FIG. 5, in another embodiment, the positions of all of the keys of the touch-control type keyboard 10 have the corresponding concave-convex structures 124 in a one to one manner. Each concave-convex structure 124 includes a frame shaped convex structure, and a symbol shaped concave structure located in the middle of the frame shaped convex structure.

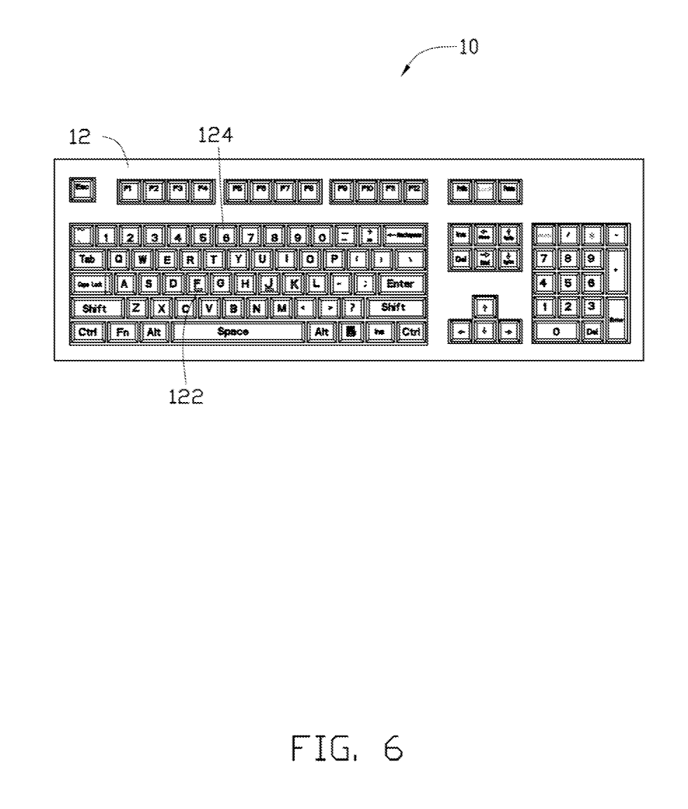

Referring to FIG. 6, in another embodiment, the positions of all of the keys of the touch-control type keyboard 10 have the corresponding concave-convex structures 124 in a one to one manner. Each concave-convex structure 124 includes a frustum shaped concave structure covering the entire region of each key. The layout of the keyboard 10 can be a QWERTY type layout, and at the position of keys “F” and “J”, the concave-convex structure 124 further includes a bar shaped concave located on the cube shaped convex structure, to emphasize two key positions.

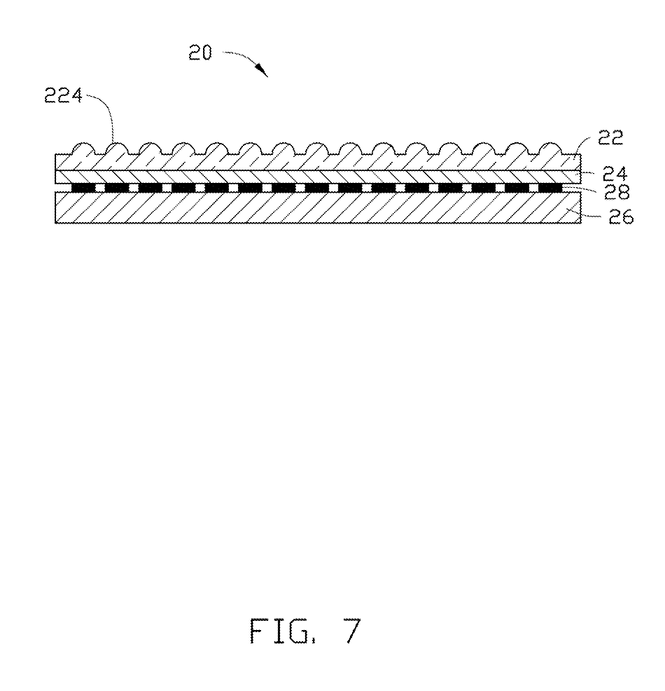

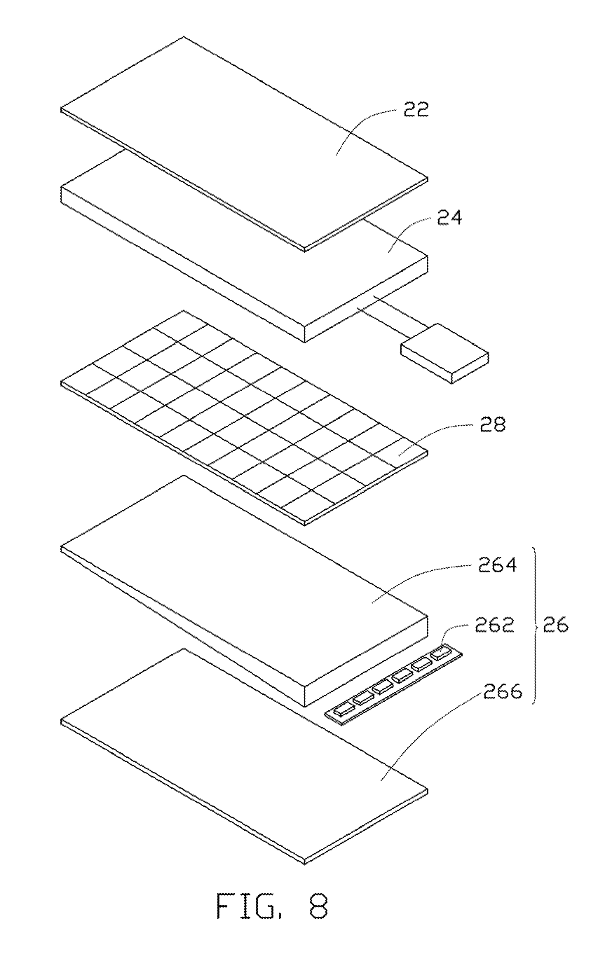

Referring to FIG. 7 and FIG. 8, a second embodiment of a touch-control type keyboard 20 includes a transparent cover board 22 and a touch-control module 24. The transparent cover board 22 and the touch-control module 24 are laminated together. The transparent cover board 22 covers the touch-control module 24, and is in contact with the touch-control module 24. The outer surfaces of the transparent cover board 22 have a plurality of concave-convex structures 224 for the user to distinguish the positions of the keys. Each concave-convex structure 224 can be a convex having a hemispherical shape. Each convex corresponds to a key position. The outer surfaces of the transparent cover board 22 between two concave-convex structures 224 are relatively smooth and flat. The outer surfaces of the transparent cover board 22 have a plurality of concave-convex structures 224 are belonged to the tactual zone. The outer surfaces of the transparent cover board 22 between the plurality of concave-convex structures 224 are belonged to the anti-tactual zone.

The structure of the second embodiment of the touch-control type keyboard 20 is similar to that of the first embodiment, except that in the second embodiment, the touch-control type keyboard 20 further includes a backlight module 26. The backlight module 26, the transparent cover board 22, and the touch-control module 24 are laminated together. The touch-control module 24 is located between the backlight module 26 and the transparent cover board 22.

The backlight module 26 can include a light source 262 and a light guide plate 264. The light guide plate 264 includes a light input surface, a light output surface, a bottom surface, and a side surface. The light input surface is connected to the light output surface. The bottom surface faces the light output surface. The side surface is connected to the light output surface and the bottom surface. The light source 262 is located at a position opposite to the light input surface. The bottom surface of the light guide plate 264 can have a reflecting film 266 reflecting the light uniformly to the light output surface. At least one of the bottom surface and the light output surface can have a plurality of microstructures to uniformly reflect the lights. The material of the light guide plate 264 can be PC, PMMA, or acrylic resin. The reflecting film 266 can be a metal film, such as an aluminum film or a silver film. The light source 262 can be a spot light source or a linear light source, such as a light emitting diode and fluorescent lamp tube. Furthermore, the light output surface can include a plurality of microstructures (not shown). The microstructure can be hemispherical, cylindrical, frustum, prism, or symbol shaped, convex, or concave. In one embodiment, each microstructure at the light output surface of the light guide plate 264 corresponds to each concave-convex structure 224 in position and/or shape. The microstructures of the light guide plate 264 can also visually emphasize the positions of the keys. The microstructures can be formed on the light guide plate 264 by using an injection molding method. In one embodiment, the microstructures are concave and hemispherical shaped.

The touch-control module 24 is adjacent to the light output surface of the light guide plate 264. The lights exit from the light output surface of the light guide plate 264 and transmit through the touch-control module 24 and the transparent cover board 22.

The touch-control type keyboard 20 can further include a keyboard marking layer 28 similar to the keyboard marking layer 18 in the first embodiment. The keyboard marking layer 28 can be located between the transparent cover board 22 and the touch-control module 24, or can be located between the touch-control module 24 and the backlight module 26. The keyboard marking layer 28 includes a plurality of key symbols used for marking the keys. The key symbols can correspond to the positions of the keys in a one to one manner The key symbols can be transparent or partially transparent. The key symbols can correspond to the concave-convex structures 224 of the transparent cover board 22 in a one to one manner. The backlight module 26 is located below the touch-control module 24 to help the user clearly see the key symbols in the keyboard marking layer 28.

The keyboard marking layer 28 can be formed on a surface of the transparent cover board 22, the touch-control module 24, or the backlight module 26 by a marking method such as screen printing, laser printing, etching, plating, and spraying.

In the second embodiment, the keyboard marking layer 28 is located between the touch-control module 24 and the backlight module 26. Each of the key symbols has a rectangular frame and a symbol such as the English letters “A” to “Z”, numbers “0” to “9”, and other symbols.

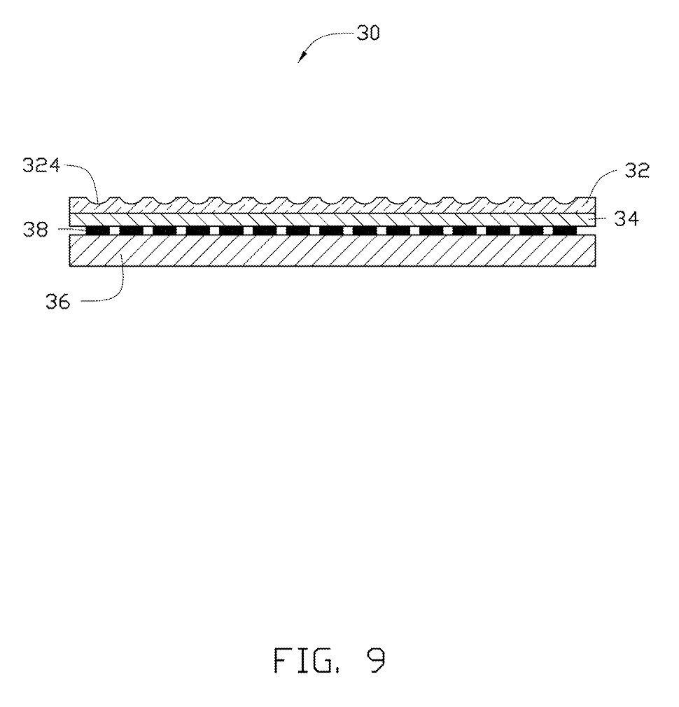

Referring to FIG. 9, a third embodiment of a touch-control type keyboard 30 includes a transparent cover board 32 and a touch-control module 34. The transparent cover board 32 and the touch-control module 34 are laminated together. The transparent cover board 32 covers and contacts the touch-control module 34. The outer surfaces of the transparent cover board 32 have a plurality of concave-convex structures 324 for the user to distinguish the positions of the keys. The outer surfaces of the transparent cover board 32 between two concave-convex structures 324 are relatively smooth and flat. The third embodiment of the touch-control type keyboard 30 can further include a keyboard marking layer 38 and a backlight module 36.

The structure of the third embodiment of the touch-control type keyboard 30 is similar to the second embodiment, except that in the third embodiment, the concave-convex structures 324 of the transparent cover board 32 are concave structures. The concave structures can be concave and hemispherical shaped with a cambered surface and a shape corresponding to a shape of a fingertip.

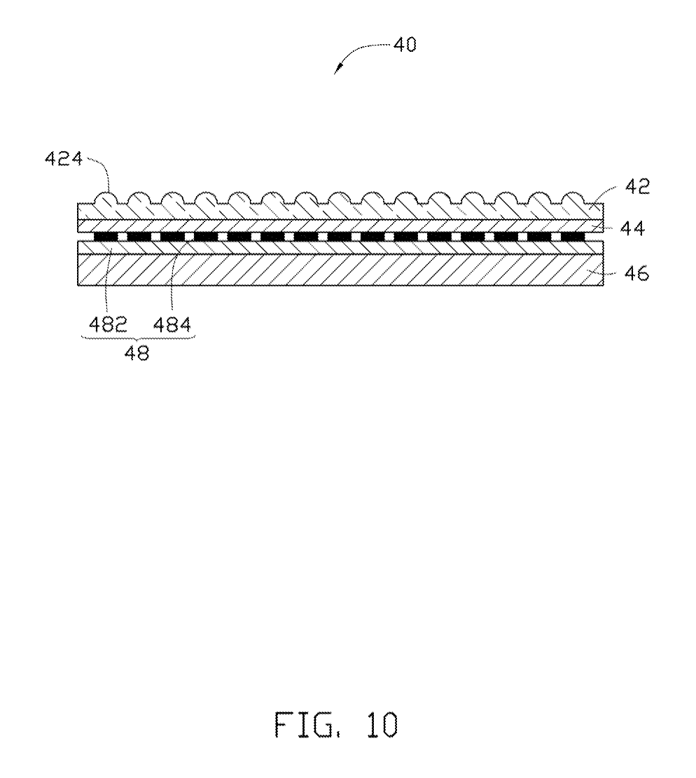

Referring to FIG. 10, a fourth embodiment of a touch-control type keyboard 40 includes a transparent cover board 42 and a touch-control module 44. The transparent cover board 42 and the touch-control module 44 are laminated together. The transparent cover board 42 covers and contacts the touch-control module 44. The outer surfaces of the transparent cover board 42 have a plurality of concave-convex structures 424 for the user to distinguish the positions of the keys.

The structure of the fourth embodiment of the touch-control type keyboard 40 is similar to the third embodiment, except that the touch-control type keyboard 40 includes a keyboard marking sheet 48. The keyboard marking sheet 48 is free-standing and can be located between the transparent cover board 42 and the touch-control module 44, or between the backlight module 46 and the touch-control module 44. The keyboard marking sheet 48 includes a transparent sheet 482 and a keyboard marking layer 484 located on a surface of the transparent sheet 482. The keyboard marking layer 484 is the same as the keyboard marking layer 28 in the second embodiment. However, the keyboard marking layer 484 is not directly printed on the other members, but printed on a separated transparent sheet 482. The keyboard marking sheet 48 can be drawn out from the touch-control type keyboard 40. Therefore, the symbols of the keys can be changed by changing the keyboard marking sheet 48 in the touch-control type keyboard 40. The input language of the keyboard 40 can also be changed by changing the keyboard marking sheet 48. The touch-control type keyboard 40 can further include a backlight module 46.

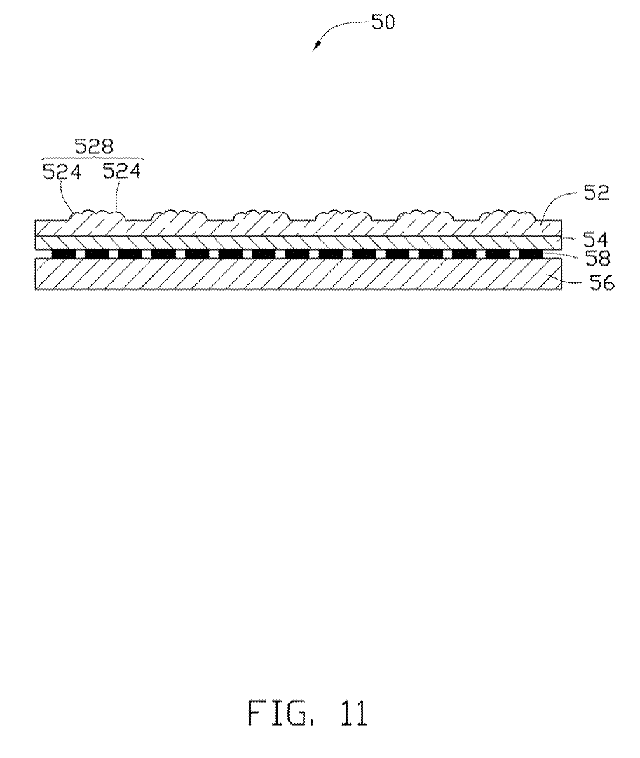

Referring to FIG. 11, a fifth embodiment of a touch-control type keyboard 50 includes a transparent cover board 52 and a touch-control module 54. The transparent cover board 52 and the touch-control module 54 are laminated together. The transparent cover board 52 covers and contacts the touch-control module 54. The outer surfaces of the transparent cover board 52 have a plurality of concave-convex structures 524 for the user to distinguish the positions of the keys.

The structure of the fifth embodiment of the touch-control type keyboard 50 is similar to the second embodiment, except that each position of the key on the transparent cover board 54 corresponds to a group of concave-convex structures 524. The transparent cover board 54 includes a plurality of concave-convex structure groups 528. Each concave-convex structure group 528 includes a plurality of concave-convex structures 524. The position of each concave-convex structure group 528 corresponds to the position of each key. The concave-convex structure groups 528 are spaced from each other a distance greater than the distance between two adjacent concave-convex structures 524 in the same concave-convex structure group 528. The outer surface of the transparent cover board 52 between two adjacent concave-convex structure groups 528 can be relatively smooth and flat. The user can distinguish the roughness from the roughness of the concave-convex structure groups 528. The plurality of the concave-convex structures 524 in the same concave-convex structure group 528 correspond to the position of one key.

The touch-control type keyboard 50 can further include a backlight module 56 and a keyboard marking layer 58. The keyboard marking layer 58 includes a plurality of key symbols 584 corresponding to the concave-convex structure groups 528 in a one to one manner.

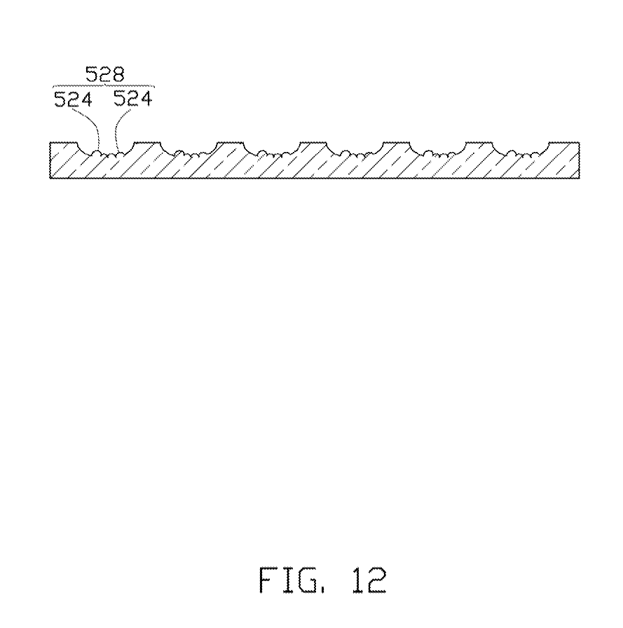

The shape of the concave-convex structure group 528 can be different from the shape of the concave-convex structure 524. Referring to FIG. 12, in another embodiment, the concave-convex structure group 528 is concave and hemispherical shaped. The concave-convex structures 524 are a plurality of hemispherical shaped convex structures located on the bottom of the hemispherical shaped concave structure.

In another embodiment, the concave-convex structure group 528 can include a rectangular shaped convex structure corresponding to a whole region of one key. The concave-convex structures 524 are a plurality of convex structures formed on the top surface of the rectangular shaped convex structure.

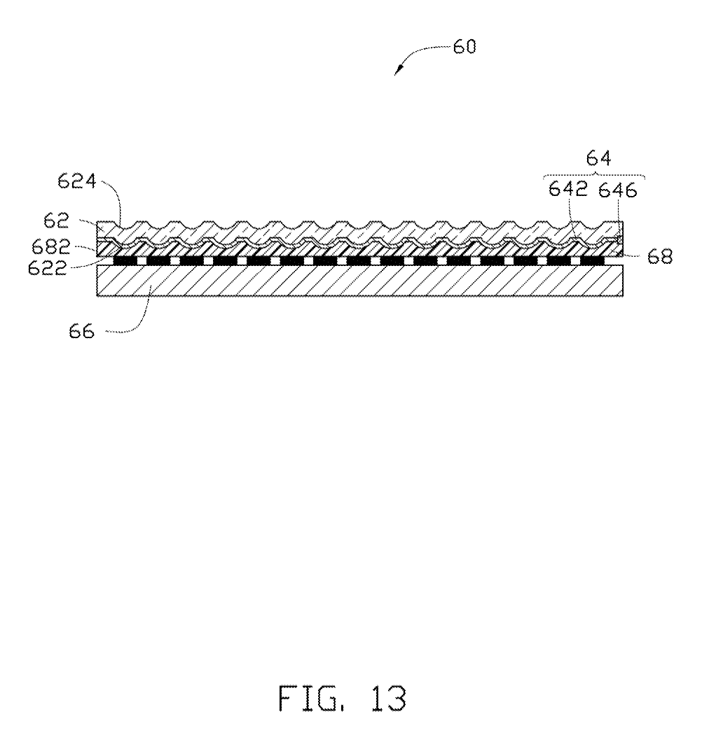

Referring to FIG. 13, a sixth embodiment of a touch-control type keyboard 60 includes a transparent cover board 62 and a touch-control module 64. The transparent cover board 62 and the touch-control module 64 are laminated together. The transparent cover board 62 covers the touch-control module 64, and is in contact with the touch-control module 64. The outer surfaces of the transparent cover board 62 have a plurality of concave-convex structures 624 for the user to distinguish the positions of keys. The outer surfaces of the transparent cover board 62 between two adjacent concave-convex structures 624 can be relatively smooth and flat. The touch-control type keyboard 60 can further include a backlight module 66 and a keyboard marking layer 68. The touch-control module 64 is located between the transparent cover board 62 and the backlight module 66. The keyboard marking layer 68 is located on a surface of the touch-control module 64 adjacent to the backlight module 66.

The structure of the sixth embodiment of the touch-control type keyboard 60 is similar to the second embodiment, except that the transparent cover board 62 further includes a plurality of negative structures 622 on an inner surface of the transparent cover board 62. The plurality of negative structures 622 correspond to the plurality of concave-convex structures 624 in a one to one manner. The inner surface is opposite to the outer surface of the transparent cover board 62. The negative structure 622 can have a shape similar and opposite to the shape of the concave-convex structure 624. If the concave-convex structure 624 is a convex structure, the negative structure 622 is a concave structure, and vise versa. The transparent cover board 62 can have the same thickness at any location. In one embodiment, the concave-convex structure 624 is a hemispherical shaped concave structure and the negative structure 622 is a hemispherical shaped convex structure.

The touch-control module 64 includes an anisotropic impedance conductive layer 642 and a plurality of electrodes 646 electrically connected to the anisotropic impedance conductive layer 642. The entire area of the anisotropic impedance conductive layer 642 can be in contact with the inner surface of the transparent cover board 62. The anisotropic impedance conductive layer 642 covers and is in contact with the negative structures 622 of the transparent cover board 62. The anisotropic impedance conductive layer 642 and the inner surface of the transparent cover board 12 can be combined by a method of in-mold decoration.

The touch-control type keyboard 60 can further include an optical adhesive layer 682 located between the anisotropic impedance conductive layer 642 and the keyboard marking layer 68 and filling the clearance between the anisotropic impedance conductive layer 642 and the keyboard marking layer 68. The transparent cover board 62, the touch-control module 64, and other members such as the backlight module 66 and the keyboard marking layer 68 can be fixed together by a fixing frame or clamps.

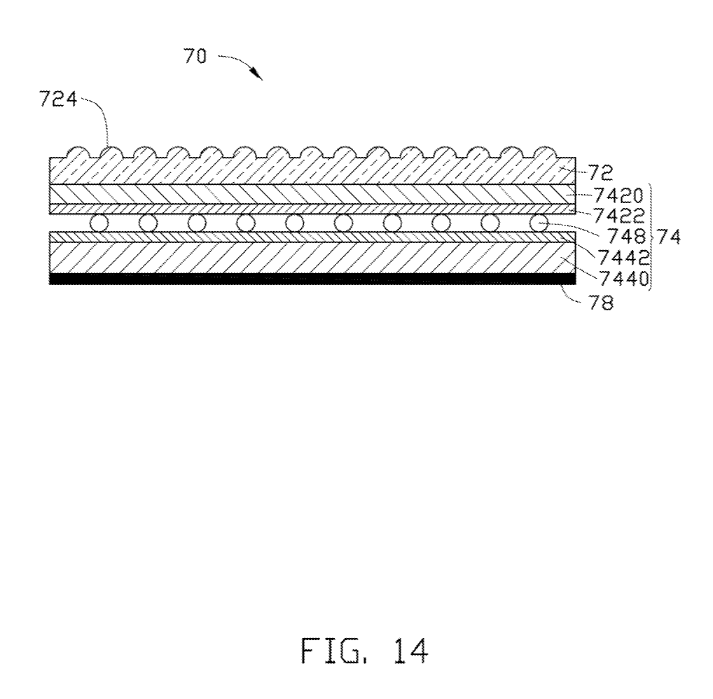

Referring to FIG. 14, a seventh embodiment of a touch-control type keyboard 70 includes a transparent cover board 72 and a touch-control module 74. The transparent cover board 72 and the touch-control module 74 are laminated together. The transparent cover board 72 covers the touch-control module 74, and is in contact with the touch-control module 74. The outer surfaces of the transparent cover board 72 have a plurality of concave-convex structures 724 for the user to distinguish the positions of the keys.

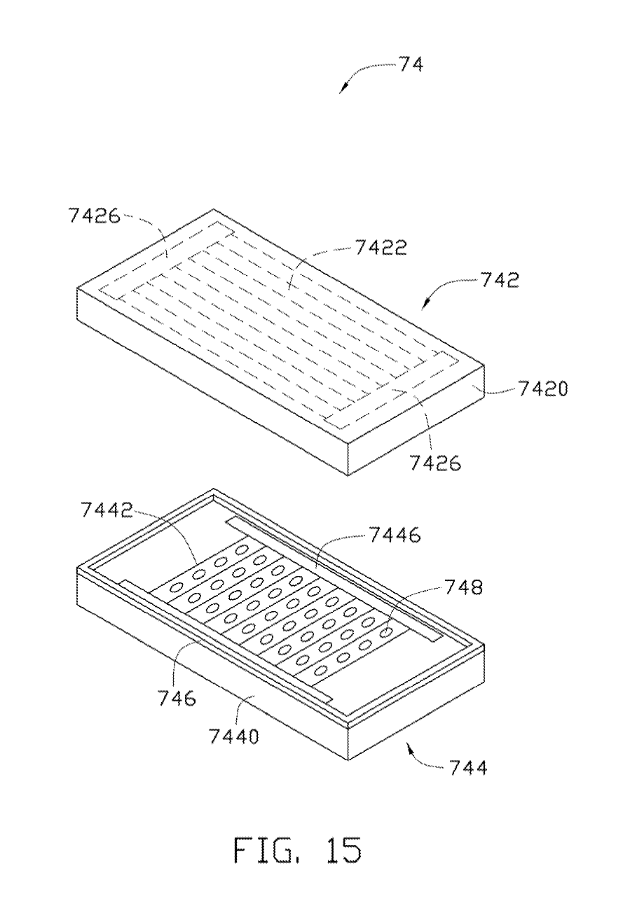

The structure of the seventh embodiment of the touch-control type keyboard 70 is similar to the second embodiment, except that the touch-control module 74 is a resistive type touch-control module 74. Referring to FIG. 15, the touch-control module 74 includes a first electrode plate 742 and a second electrode plate 744 opposite to and spaced from the first electrode plate 742. The first electrode plate 742 includes a first substrate 7420, a first transparent conductive layer 7422 and two first electrodes 7426 located on an inner surface of the first substrate 7420. The two first electrodes 7426 are respectively located on two opposite ends of the first transparent conductive layer 7422. A direction from one first electrode 7426 to the other first electrode 7426 is defined as a first direction. The second electrode plate 744 includes a second substrate 7440, a second transparent conductive layer 7442, and two second electrodes 7446 located on an inner surface of the second substrate 7440. The two second electrodes 7446 are respectively located on two opposite ends of the second transparent conductive layer 7442. A direction from one second electrode 7446 to the other second electrode 7446 is defined as a second direction. The first direction is substantially perpendicular to the second direction. The two first electrodes 7426 are substantially perpendicular to the two second electrodes 7446.

The touch-control type keyboard 70 can further include a keyboard marking layer 78. The keyboard marking layer 78 is located on a lower surface of the second substrate 7440 of the touch-control module 74.

The first substrate 7420 is made of flexible transparent material. The second substrate 7440 is made of rigid or flexible transparent material. In one embodiment, the first substrate 7420 is a polyester film, and the second substrate 7440 is a glass plate. The first transparent conductive layer 7422 faces the second transparent conductive layer 7442. The resistive type touch-control module can further include a adhesive layer 746 located at edges of the first substrate 7420 between the first substrate 7420 and the second substrate 7440, to combine the first substrate 7420 and the second substrate 7440 together. A plurality of spacers 748 can be arranged between the first transparent conductive layer 7422 and the second transparent conductive layer 7442. The spacers 748 space the first transparent conductive layer 7422 from the second transparent conductive layer 7442 when the touch-control module 74 is not pressed.

The first transparent conductive layer 7422 and the second transparent conductive layer 7442 can be an indium tin oxide film or a carbon nanotube film. A thickness of the carbon nanotube film can be in a range from about 0.5 nanometers to about 100 microns. In one embodiment, the carbon nanotube film is drawn from a carbon nanotube array and has an anisotropic impedance conductive property. In the first transparent conductive layer 7422, the carbon nanotubes in the carbon nanotube film are substantially aligned along the first direction. In the second transparent conductive layer 7442, the carbon nanotubes in the carbon nanotube film are substantially aligned along the second direction.

The first electrodes 7426 and the second electrodes 7446 can be made of a low resistance material such as copper, silver, and aluminum, to minimize the signal attenuation. In one embodiment, the first electrodes 7426 and the second electrodes 7446 are made of silver paste.

The first substrate 7420 of the touch-control module 74 and the transparent cover board 72 can be an integrated structure. The concave-convex structures 724 can be directly formed on the outer surface of the first substrate 7420.

In another embodiment, the touch-control module can be a multi touch capacitance type touch-control module including a substrate and two transparent conductive layers located on two opposite surfaces of the substrate. The material of the transparent conductive layer can be metal oxides, such as a plurality of spaced indium tin oxide strips, or an anisotropic impedance carbon nanotube film. In one embodiment, one of the two transparent conductive layers is the anisotropic impedance carbon nanotube film and the other of the two transparent conductive layers is the plurality of spaced indium tin oxide strips.

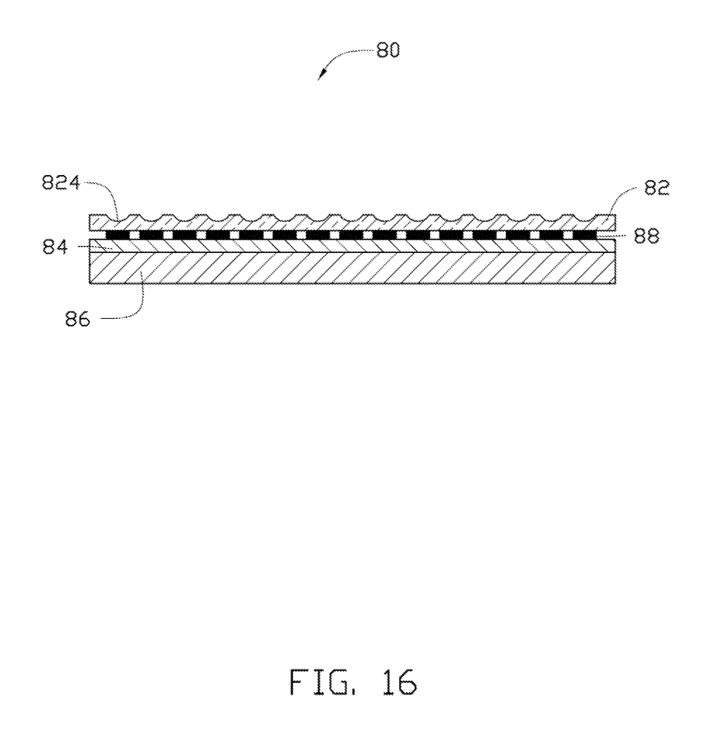

Referring to FIG. 16, an eighth embodiment of a touch-control type keyboard 80 includes a transparent cover board 82 and a touch-control module 84. The transparent cover board 82 and the touch-control module 84 are laminated together. The transparent cover board 82 covers the touch-control module 84, and is in contact with the touch-control module 84. The outer surfaces of the transparent cover board 82 have a plurality of concave-convex structures 824 for the user to distinguish the positions of the keys. The inner surface of the transparent cover board 82 includes a printed keyboard marking layer 88. The touch-control type keyboard 80 can further include a backlight module 86. The touch-control module 84 is located between the transparent cover board 82 and the backlight module 86.

The structure of the eighth embodiment of the touch-control type keyboard 80 is similar to the first embodiment, except that the keyboard marking layer 88 directly combines with the transparent cover board 82. The keyboard marking layer 88 includes a plurality of key symbols corresponding to the positions of the keys in a one to one manner The position of each concave-convex structure 824 is the position of one key, and corresponding to one key symbol. The concave-convex structures 824 and the key symbols of the keyboard marking layer 88 are correspondingly formed on the two opposite surfaces of the transparent cover board 82. Therefore, in the assembling process of the touch-control type keyboard 80, the non-alignment of the keyboard marking layer 88 and the concave-convex structures 824 can be avoided.

In another embodiment, the keyboard marking layer 88 can be formed on the outer surface of the transparent cover board 82 to cover the concave-convex structures 824.

Finally, it is to be understood that the above-described embodiments are intended to illustrate rather than limit the present disclosure. Variations may be made to the embodiments without departing from the spirit of the present disclosure as claimed.

Elements associated with any of the above embodiments are envisioned to be associated with any other embodiments. The above-described embodiments illustrate the scope of the present disclosure but do not restrict the scope of the present disclosure.

What is claimed is:

1. A touch-control type keyboard comprising:
a transparent cover board comprising an outer surface and an inner surface opposite to the outer surface; and
a touch-control module laminated to the inner surface of the transparent cover board, wherein the outer surface of the transparent cover board comprises a tactual zone and a relative anti-tactual zone, the tactual zone comprises a plurality of micro structures on the outer surface.

2. The touch-control type keyboard of claim 1, wherein the tactual zone of the outer surface of the transparent cover board defines a plurality of keys.

3. The touch-control type keyboard of claim 2, wherein the plurality of micro structures of the tactual zone is a plurality of convex structures, and a position of each of the plurality of convex structures corresponds to a position of one of the plurality of keys.

4. The touch-control type keyboard of claim 3, wherein each of the plurality of convex structures is a protruded hemispherical, cylindrical, frustum, prism, or symbol shaped protrusion.

5. The touch-control type keyboard of claim 2, wherein the plurality of micro structures of the tactual zone is a plurality of concave structures, and a position of each of the plurality of concave structures corresponds to a position of one of the plurality of keys.

6. The touch-control type keyboard of claim 5, wherein each of the plurality of concave structures is concave and hemispherical shaped with a cambered surface corresponding to a shape of a fingertip.

7. The touch-control type keyboard of claim 2, wherein the plurality of micro structures of the tactual zone is a plurality of convex structures or a plurality of concave structures, and a height of the convex structures and a depth of the concave structures are in a range from about 50 microns to about 2 millimeters.

8. The touch-control type keyboard of claim 2, wherein the plurality of micro structures has a QWERTY keyboard layout, and the plurality of micro structures at positions of keys “F” and “J” are bar shaped protrusions.

9. The touch-control type keyboard of claim 2, wherein the plurality of micro structures are symbol-shaped convex structures or symbol-shaped concave structures.

10. The touch-control type keyboard of claim 2, further comprising a keyboard marking layer located on the outer surface of the transparent cover board.

11. The touch-control type keyboard of claim 2 further comprising a backlight module, and the touch-control module is located between the backlight module and the transparent cover board.

12. The touch-control type keyboard of claim 11, further comprising a keyboard marking layer located between the touch-control module and the backlight module, the keyboard marking layer comprises a plurality of key symbols corresponding to the plurality of micro structures of the tactual zone of the transparent cover board in a one to one manner.

13. The touch-control type keyboard of claim 11 further comprising a keyboard marking sheet located between the backlight module and the touch-control module, the keyboard marking sheet comprises a transparent sheet and a keyboard marking layer located on a surface of the transparent sheet, and the keyboard marking layer comprises a plurality of key symbols corresponding to the plurality of micro structures of the tactual zone of the transparent cover board in a one to one manner.

14. The touch-control type keyboard of claim 2, wherein the touch-control module comprises an anisotropic impedance conductive layer and a plurality of electrodes electrically connected to the anisotropic impedance conductive layer, and the anisotropic impedance conductive layer is in contact with the inner surface of the transparent cover board.

15. The touch-control type keyboard of claim 14, wherein the inner surface of the transparent cover board further comprises a plurality of negative structures corresponding to the plurality of micro structures in a one to one manner.

16. The touch-control type keyboard of claim 15, wherein the anisotropic impedance conductive layer is a carbon nanotube film.

17. The touch-control type keyboard of claim 2, wherein the outer surface comprises a plurality of micro structure groups, and each of the plurality of micro structure groups comprises the plurality of micro structures.

18. The touch-control type keyboard of claim 17, wherein a position of each of the plurality of micro structure groups corresponds to a position of one of the plurality of keys.
